(19) United States
(12) Patent Application Publication
(10) Pub. No.: US 2010/0058134 A1
(43) Pub. Date: Mar. 4, 2010

(54) INFORMATION PROCESSING APPARATUS, AND CONTROL METHOD, PROGRAM AND RECORDING MEDIUM THEREFOR

(75) Inventor: Ken Matsui, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/535,279

(22) Filed: Aug. 4, 2009

(30) Foreign Application Priority Data
Aug. 28, 2008 (JP) 2008-220503

(51) Int. Cl. H04L 1/18; G06F 11/14

(52) U.S. Cl. 714/748; 714/E11.113

(57) ABSTRACT

An information processing apparatus that receives image data sent from a sending apparatus in packet communications, the information processing apparatus includes: a receiving unit adapted to receive a packet for transmitting the image data; a detecting unit adapted to detect a transmission error in the packet; and a sending unit adapted to send a retransmission request for a packet in which the detecting unit has detected a transmission error to the sending apparatus; wherein, when the detecting unit has detected a transmission error in a packet that corresponds to a region of interest that has been preset in the image data, the sending unit sends a retransmission request for the packet with a higher priority than a transmission request for a packet that does not correspond to the region of interest.

### BACKGROUND OF THE INVENTION

1. Field of the Invention

The present invention relates to an information processing apparatus, and a control method, program and recording medium therefor, and in particular, it relates to packet retransmission control in transmitting images in packet communications.

2. Description of the Related Art

In recent years, with increasing computer system performance and the increasing speed of communication media, moving-image transmission among network-connected information equipment has been in widespread practice. In particular, moving-image transmission on a network using Ethernet (registered trademark) and the Internet Protocol (IP) has become prevalent.

Against this backdrop and because of the low-cost and easy procurement of high-speed network equipment, moving-image transmission using IP is starting to be used similarly in transmission among the parts of information equipment. For example, vehicle-mounted camera systems have started using moving-image transmission between their camera units and image processing units that are connected via Ethernet (registered trademark).

For a network that takes part in such moving-image transmission within information equipment, the number of nodes connected to the network is often more limited than in the case of a general-purpose computer network. Thus, even if moving-image transmission is performed, there is generally still sufficient communication throughput. The reliability of intra-equipment data transmission has thus conventionally been secured using TCP (Transmission Control Protocol), which has an error correcting function by means of defective and lost packet retransmission.

However, as moving images to be handled have higher frame rates and higher resolutions, there is a lower amount of extra communication throughput and it is becoming difficult to completely perform defective-packet retransmission. In particular, if delays between the start of moving-image transmission and the display of moving images need to be minimized as much as possible, the reliability of such transmitted data has to be sacrificed in some cases in order to achieve a predetermined frame rate within a limited time and with a limited amount of communication throughput.

In view of this background, Japanese Patent Laid-Open No. 10-262256 has disclosed a configuration in which an upper limit for the number of retransmissions is set in order to cope with such a situation where there is a small number of extra communication throughput. With this configuration, since an upper limit for the number of retransmissions is set for each transmitted packet, equal retransmission opportunities are given to each packet.

Japanese Patent Laid-Open No. 2003-218934 has disclosed a configuration in which the sequence of retransmission is controlled so that more retransmission opportunities are given to important packets.

Both the conventional techniques described above secure the reliability of transmitted data on a best-effort basis.

However, in actuality, there are types of information equipment that do not allow degradation in the reliability of data. For example, equipment such as a diagnostic apparatus that deals with medical images falls under such a category. As for equipment that deals with medical images, the reliability of image data has a direct relationship with the reliability of medical practice, so image data must be transmitted with reliability. In addition, sufficient information for a doctor to make a diagnosis must be provided. In other words, moving images handled by a medical image processing apparatus require high frame rates, high resolutions, and a minimum of delays between image capture and display. Conventional techniques have failed to fulfill such requirements.

### SUMMARY OF THE INVENTION

The present invention has been made in view of the problems described above and aims to provide a technique for transmitting image data while securing the required reliability, through a communication path that does not always secure the reliability of data transmission.

According to one aspect of the present invention, an information processing apparatus that receives image data sent from a sending apparatus in packet communications, the information processing apparatus includes: a receiving unit adapted to receive a packet for transmitting the image data; a detecting unit adapted to detect a transmission error in the packet; and a sending unit adapted to send a retransmission request for a packet in which the detecting unit has detected a transmission error to the sending apparatus; wherein, when the detecting unit has detected a transmission error in a packet that corresponds to a region of interest that has been preset in the image data, the sending unit sends a retransmission request for the packet with a higher priority than a transmission request for a packet that does not correspond to the region of interest.

According to another aspect of the present invention, a method of controlling an information processing apparatus that receives image data sent from a sending apparatus in packet communications, the method includes: a receiving step of receiving a packet for transmitting the image data; a detecting step of detecting a transmission error in the packet; and a sending step of sending a retransmission request for a packet in which a transmission error has been detected in the detecting step to the sending apparatus; wherein, when a transmission error in a packet that corresponds to a region of interest that has been preset in the image data has been detected in the detecting step, a retransmission request for the packet is sent in the sending step with a higher priority than a transmission request for a packet that does not correspond to the region of interest.

Further features of the present invention will become apparent from the following description of exemplary embodiments (with reference to the attached drawings).

### BRIEF DESCRIPTION OF THE DRAWINGS

FIG. 1 is a block diagram illustrating a functional configuration of a diagnostic apparatus.

FIG. 2 is a schematic diagram illustrating an exemplary structure of a packet generated by a packet sending unit.

FIG. 3 is a block diagram illustrating a hardware configuration of a diagnostic apparatus.

FIG. 4 is a flow chart showing the operation of a display device when receiving an image.

FIGS. 5A to 5C show an example of the difference in transmission results between when to correct transmission errors and when not to.

FIG. 6 is a flow chart showing the operation of a display device when receiving an image.

FIG. 7 is a flow chart showing the operation of a display device when receiving an image.

### DESCRIPTION OF THE EMBODIMENTS

Hereinafter, exemplary embodiments of the present invention will be described in detail with reference to the accompanying drawings. Note that the components described in the exemplary embodiments are only illustrative and not intended to limit the scope of the present invention. It is also noted that not all combinations of the features described in the exemplary embodiments are essential to solve the problem of the present invention.

### Embodiment 1

Diagnostic Apparatus

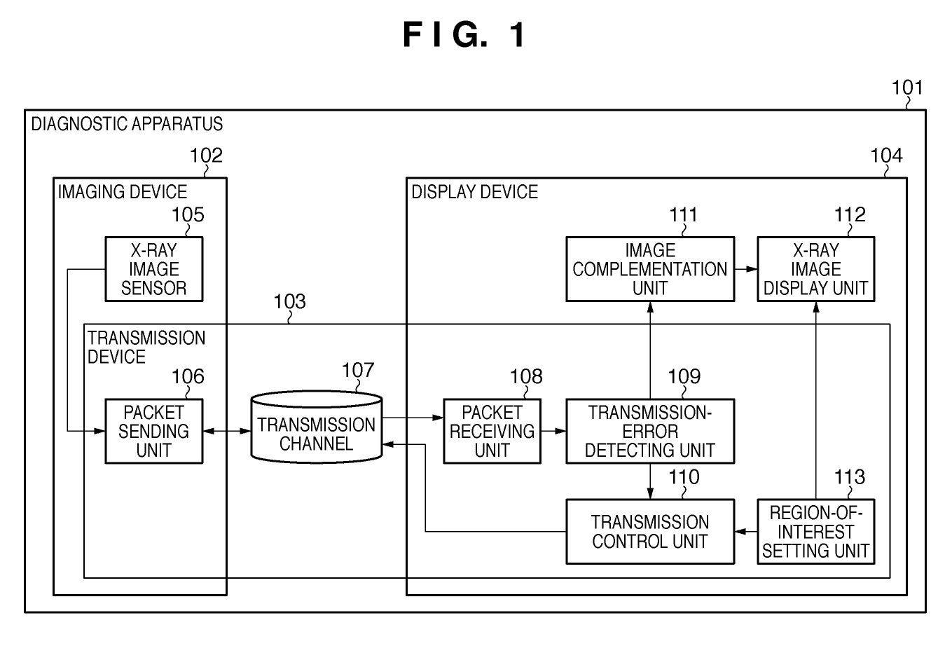

As a first exemplary embodiment of the present invention, a diagnostic apparatus (digital X-ray image diagnostic apparatus) 101 using X-ray radioscopy will be described with reference to FIG. 1. Note that this apparatus associates a plurality of X-ray images captured over a continuous time with frames to generate moving images, for implementation of X-ray radioscopy.

FIG. 1 is a block diagram illustrating a configuration of the diagnostic apparatus 101 according to the present exemplary embodiment. The diagnostic apparatus 101 includes an imaging device (X-ray image capture device) 102 that captures X-ray images, and a display device (X-ray image display device) 104 that displays X-ray images obtained by image capture. The imaging device 102 serves as a sending device that sends packets for transmitting image data, and the display device 104 serves as an information processor that receives image data sent from the sending device in packet communications. In the present example, a transmission device (image transmission device) 103 is used to transmit images between the imaging device 102 and the display device 104.

As illustrated in FIG. 1, the imaging device 102 includes an X-ray image sensor 105 and a packet sending unit 106.

The X-ray image sensor 105 generates X-ray image data through photo-electric conversion of X-rays incident from the outside. The packet sending unit 106 divides the X-ray image data generated by the X-ray image sensor 105 into packets and sends those packets out to a transmission channel 107. The header information of those packets includes an error detecting code such as a checksum. It may also include information for use in determining the line or frame border of an image.

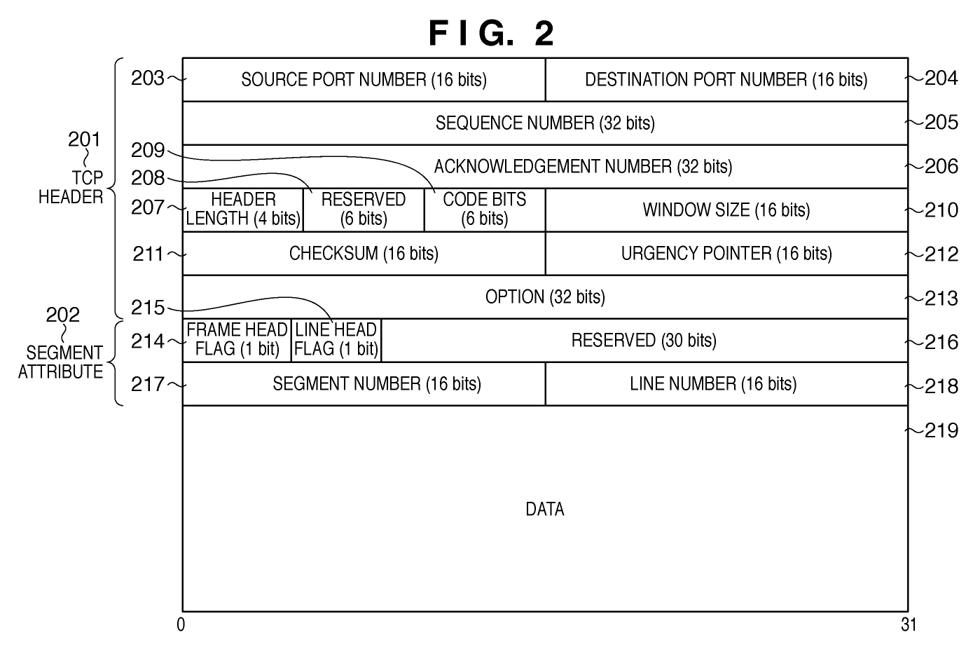

In the present exemplary embodiment, packets are configured in a format based on TCP/IP, as illustrated in FIG. 2. FIG. 2 is a schematic diagram illustrating an exemplary configuration of a packet generated by the packet sending unit 106.

The present exemplary embodiment adopts a format that records a segment attribute 202 on an 8-byte area that follows a TCP header 201. The segment attribute 202 includes a frame head flag 214, a line head flag 215, a segment number 217, and a line number 218.

If the frame head flag 214 is “1”, it indicates that data 219 stored in this segment is at the head of a frame. Similarly, if the line head flag 215 is “1”, it indicates that the data 219 is at the head of a line. The segment number 217 indicates a segment number in a line to which the segment belongs. The line number 218 indicates a number of a line in a frame to which the segment belongs.

A source port number 203 is a port number used for packet transmission, and a destination port number 204 is a port number used for packet reception. A sequence number 205 is used as a serial number of the packet, and an acknowledgement number 206 is used to associate a packet with an acknowledgement signal (ACK).

A header length 207 indicates the length of the packet header, and reserved fields 208 and 216 indicate reserved fields. Code bits 209 are used to indicate a type of a TCP segment, and a window size 210 indicates a window size in TCP communications. A checksum 211 is a checksum value used to correct an error, and an urgency pointer 212 indicates the position of the end of urgency data that is included in the TCP segment. An option 213 is an optional field.

The transmission channel 107 connects the imaging device 102 and the display device 104. In the present exemplary embodiment, the transmission channel 107 is implemented according to the standards of Ethernet (registered trademark), using TCP/IP as a communication protocol. Note that the communication protocol may adhere to any other standard, as long as retransmission is possible.

A packet receiving unit 108 receives a packet transmitted from the packet sending unit 106 through the transmission channel 107.

A transmission-error detecting unit 109 detects the presence or absence of a transmission error in a packet received by packet receiving unit 108. A transmission error is detected using an error detecting code, such as the checksum 211 described above, that is attached to the packet as a header. Note that the primary cause of a transmission error is external noise in the transmission channel 107.

A transmission control unit 110 has a function of requesting the packet sending unit 106 to retransmit a packet from which the transmission-error detecting unit 109 has detected a transmission error. Whether or not to retransmit a packet is determined under packet retransmission conditions, which will be described later.

An image complementation unit 111 reconstructs original X-ray image data from received packets as well as complementing an image displayed in a region of the image that corresponds to a packet not having been received by the packet receiving unit 108.

An X-ray image display unit 112 displays an X-ray image reconstructed by the image complementation unit 111 as well as displaying a region of interest that has been set by a region-of-interest setting unit 113.

The region-of-interest setting unit 113 sets a region of interest in a transmitted image. In general, a region of interest corresponds to a part that is necessary for diagnosis, that is, the affected part. For example, if a chest X-ray image captured from the front of a human body is used to observe the focus on the right lung, the left half of the image will be the region of interest. Note that, in the present exemplary embodiment, a region of interest may be set manually through a user interface UI 311, which will be described later.

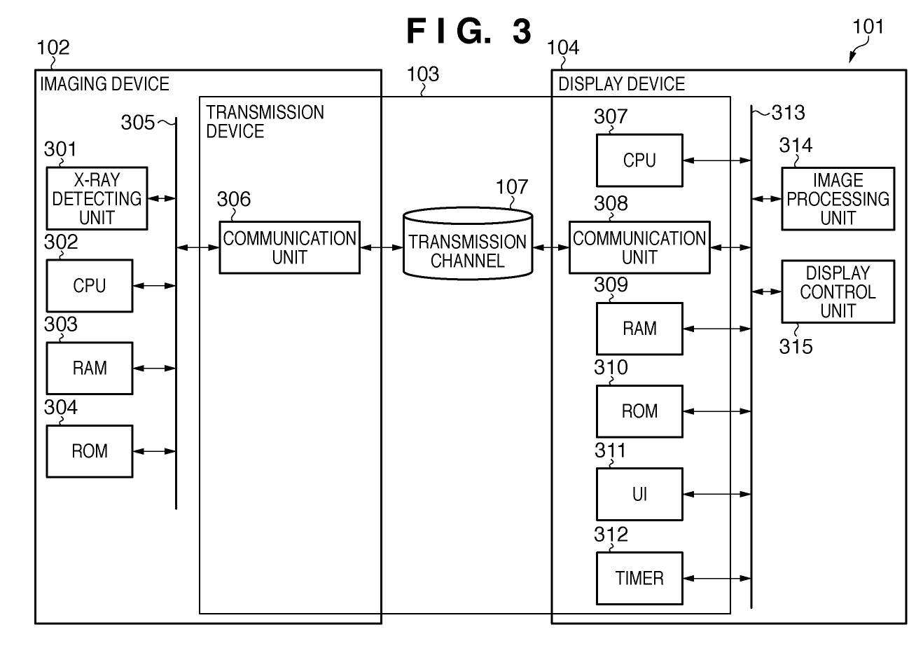

FIG. 3 is a block diagram illustrating a hardware configuration (circuit block) of the diagnostic apparatus 101.

As illustrated in FIG. 3, the imaging device 102 includes an X-ray detecting unit 301, a CPU 302, a RAM 303, a ROM 304, a communication unit 306, and a bus 305 that connects all of the above.

The X-ray detecting unit 301 detects X rays that have been emitted from an X-ray source (not shown) to the X-ray detecting unit 301 so as to transmit an imaging target, and generates digital X-ray image data. The CPU 302 is a central processing unit, under the control of which programs such as an application program, an operating system (OS), and a control program are executed, and information, files, and the like that are necessary for the execution of such programs are temporarily stored in the RAM 303.

The RAM 303 is a writable memory that is used to temporarily store a variety of data and serves as a main memory, a work area, and the like of the CPU 302. The ROM 304 is a read-only memory that stores programs, such as a basic I/O program, and a variety of data used in basic processing.

The communication unit 306 is a communication interface that provides communications with the display device 104 through the transmission channel 107. The bus 305 takes charge of data flow in the imaging device 102.

The display device 104 includes a CPU 307, a communication unit 308, a RAM 309, a ROM 310, the UI (user interface) 311, a timer 312, an image processing unit 314, a display control unit 315, and a bus 313 that connects all of the above.

The CPU 307, the communication unit 308, the RAM 309, the ROM 310, and the bus 313 respectively operate similarly to the CPU 302, the communication unit 306, the RAM 303, the ROM 304, and the bus 305 of the imaging device 102.

The UI (user interface) 311 is an interface that accepts the input of instructions from a user, and it may be implemented by a keyboard, a pointing device (e.g., a mouse), a touch panel, and the like, for example. The timer 312 is a device that counts time, and in the present exemplary embodiment, it serves as a measuring device that measures an elapsed time after starting to receive packets of image data. The timer 312 may be implemented by a quartz-crystal resonator, for example.

The image processing unit 314 processes an image received from the imaging device 102 and generates a display image. The display control unit 315 outputs and displays the display image generated by the image processing unit 314 on a monitor (not shown).

The functions of the diagnostic apparatus 101 are implemented by cooperative operation of various types of hardware and software operating on the hardware.

Reception Processing

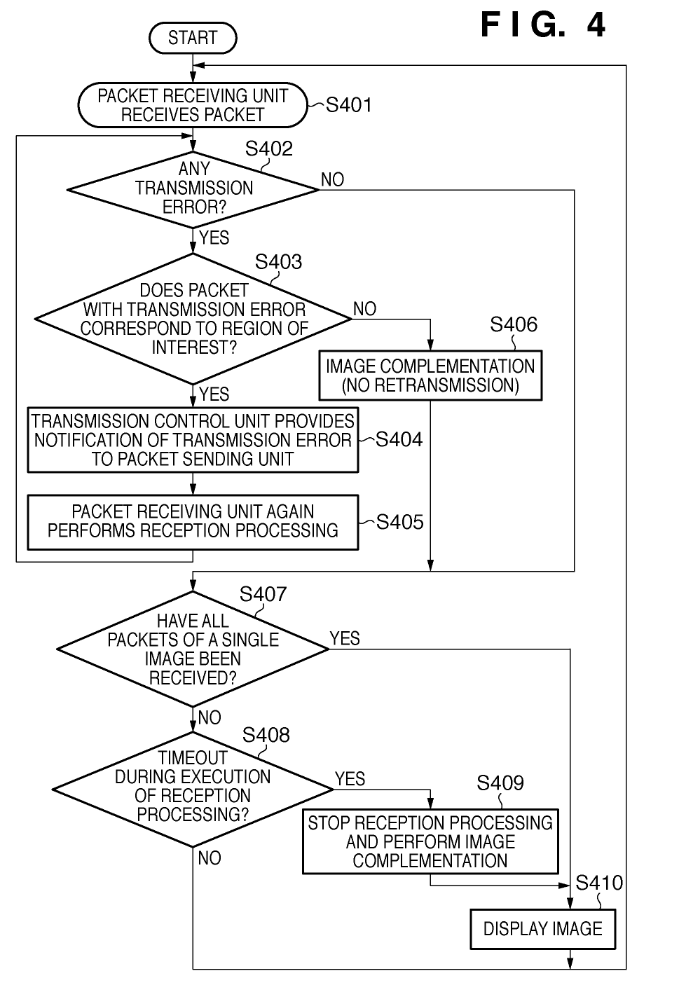

Next, a procedure for receiving an image in the present exemplary embodiment will be described with reference to FIG. 4. FIG. 4 is a flow chart showing the operation of the display device 104 when receiving an image. The reception processing is performed under the control of the CPU 307.

First, the packet receiving unit 108 performs reception processing, that is, receives a packet of X-ray image data, in step S401.

Then, whether or not a received packet has encountered a transmission error is determined in step S402. If no transmission error has occurred (NO in step S402), the process proceeds to step S407. If a transmission error has occurred (YES in step S402), on the other hand, the process proceeds to step S403. Note that such a determination may be made using an error detecting code such as the checksum 211, as described above, or by finding a missing sequence number 205, for example.

In step S403, it is determined whether or not the packet having encountered a transmission error corresponds to a region of interest. If the packet does not correspond to a region of interest (NO in step S403), the process proceeds to step S406. If the packet corresponds to a region of interest (YES in step S403), on the other hand, the process proceeds to step S404. Note that the region of interest has been preset through the UI 311. In step S403, if the packet having encountered a transmission error transmits image data that is included in the region of interest, it is determined as corresponding to the region of interest.

In step S404, the transmission control unit 110 gives a notification that a transmission error has been detected in a transmitted packet to the packet sending unit 106. In response to this, the packet sending unit 106 retransmits the packet.

In step S405, the packet receiving unit 108 receives the retransmitted packet. The process then returns to step S402 for again checking whether the retransmitted packet has not encountered a transmission error.

In step S406, a region of the image that corresponds to a packet having encountered a transmission error is subjected to image complementation. In other words, a retransmission request is not issued for a packet that does not correspond to a region of interest.

In step S407, it is determined whether or not all the packets of a single image (or frame) have been received. If reception has been completed (YES in step S407), the process proceeds to step S410 to display an image, and then returns to step S401 to prepare to start receiving the next piece of image data. On the other hand, if reception has not been completed yet (NO in step S407), the process proceeds to step S408.

In step S408, whether or not a timeout has occurred during the execution of reception processing is determined. If a timeout has occurred (YES in step S408), the process proceeds to step S409 to stop packet reception processing for the image currently being acquired. In stopping reception processing, a region of the image that corresponds to a packet not having been received is subjected to image complementation. The process then proceeds to step S410 to display the image, and returns to step S401 to prepare to start receiving the next piece of image data.

On the other hand, if a timeout has not occurred in step S408 (NO in step S408), the process returns to step S401 to receive the following packet.

Note that a timeout period may be set based on the frame rate of moving images during X-ray radioscopy. For example, it is determined that a timeout has occurred when a period of time equivalent to the frame interval plus a predetermined value of time has elapsed after the reception of a previous frame. Note that the determination of a timeout may be made with the timer 312.

Exemplary Operation

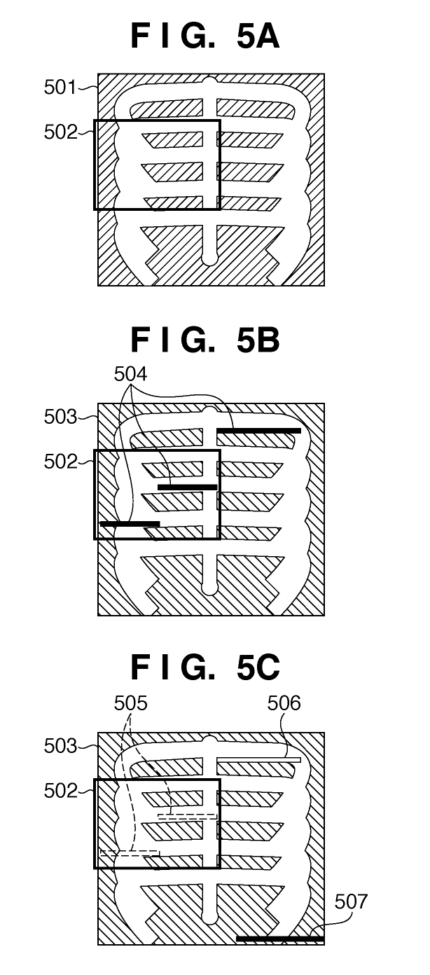

Next, the effect of the case where an image is transmitted with the above functional configuration and through the above procedure will be described with reference to FIGS. 5A to 5C. FIGS. 5A to 5C show a difference in transmission results between when to correct a transmission error and when not to in transmitting a human's chest X-ray image.

FIG. 5A illustrates an example of the case where the region-of-interest setting unit 113 has set a right lung as a region of interest 502.

An auxiliary region-of-interest setting image 501 is an image that is displayed prior to transmission of an X-ray image 503 in order to make it easier for a user to set a region of interest 502. A region of interest 502 needs to be set prior to the transmission of an X-ray image 503, but it is generally difficult to set a region of interest properly without knowing which kind of image is to be transmitted. In the present exemplary embodiment, an auxiliary region-of-interest setting image 501 displayed is, for example, an X-ray image of the next previous frame of an X-ray image 503 or a typical X-ray image of a part to be captured. Displaying the auxiliary region-of-interest setting image 501 allows a user to predict the outline of an X-ray image 503 prior to image transmission and accordingly makes it easier for a user to set a region of interest 502.

FIG. 5B illustrates an example of an X-ray image 503 obtained when transmission errors are not corrected. In the present example, regions 504 of the image that correspond to a packet that encountered a transmission error are marked as darkened areas in the X-ray image 503.

FIG. 5C illustrates an example of an X-ray image 503 that is obtained when transmission errors are corrected according to the flow chart shown in FIG. 4. From among the regions of the image that correspond to a packet having encountered a transmission error, regions 505 that correspond to the region of interest 502 are subjected to error correction by means of retransmission. Thus, even if a transmission error occurs, a highly reliable image is displayed in the region of interest 502.

On the other hand, a region 506 that does not correspond to the region of interest 502 is subjected to image complementation. A region 507 that corresponds to a packet not having been received due to a timeout is also subjected to image complementation. Thus, the image displayed outside the region of interest 502 is less reliable than the image displayed in the region of interest 502. One reason for a timeout is the delays caused by the retransmission of packets that correspond to the regions 505.

Note that in the examples shown in FIGS. 5A to 5C, the boundary of the region of interest 502 agrees with the boundary of segments obtained by dividing an image into packets, but in general, those boundaries may not overlap with each other. In the case where those boundaries do not overlap with each other, if part of a region that corresponds to a certain packet overlaps with the region of interest 502, that packet may be determined as corresponding to the region of interest 502. Alternatively, such determination of whether a packet corresponds to the region of interest 502 or not may be made depending on the extent to which a region corresponding to that packet overlaps with the region of interest 502.

As described above, the display device 104 receives a packet for transmitting image data, detects a transmission error in a packet, and sends a retransmission request for a packet from which a transmission error has been detected to the imaging device 102. At this time, if a transmission error has been detected in a packet that corresponds to a region of interest that has been preset in image data, a retransmission request for the packet is sent with a higher priority than a transmission request for a packet that does not correspond to the region of interest. The configuration of the present exemplary embodiment can thus secure the reliability of a transmitted image regarding a region of interest while allowing real-time image transmission, even if a communication path does not always secure the reliability of data transmission.

Moreover in the present exemplary embodiment, a retransmission request for a packet that does not correspond to a region of interest is not sent even if a transmission error has been detected in the packet. The configuration of the present exemplary embodiment can thus secure the reliability of an image regarding a region of interest, even if a communication path does not secure sufficient communication throughput.

In the present exemplary embodiment, an elapsed time after starting to receive packets of image data is measured with the timer 312, and if the elapsed time exceeds a predetermined upper limit, the reception of packets is stopped and an image is displayed. The configuration of the present exemplary embodiment thus enables appropriate real-time moving-image transmission.

Since, in the present exemplary embodiment, a region of interest is set according to a user instruction, a region of interest that needs to secure reliability in data transmission can be set properly according to the purpose of the user.

### Embodiment 2

Next, a diagnostic apparatus 101 according to a second exemplary embodiment (Embodiment 2) of the present invention will be described. In the configuration according to the present exemplary embodiment, an upper limit is set for the number of packet retransmissions so as to prevent a packet retransmission request from continuing to be issued unnecessarily when a transmission error continues to occur.

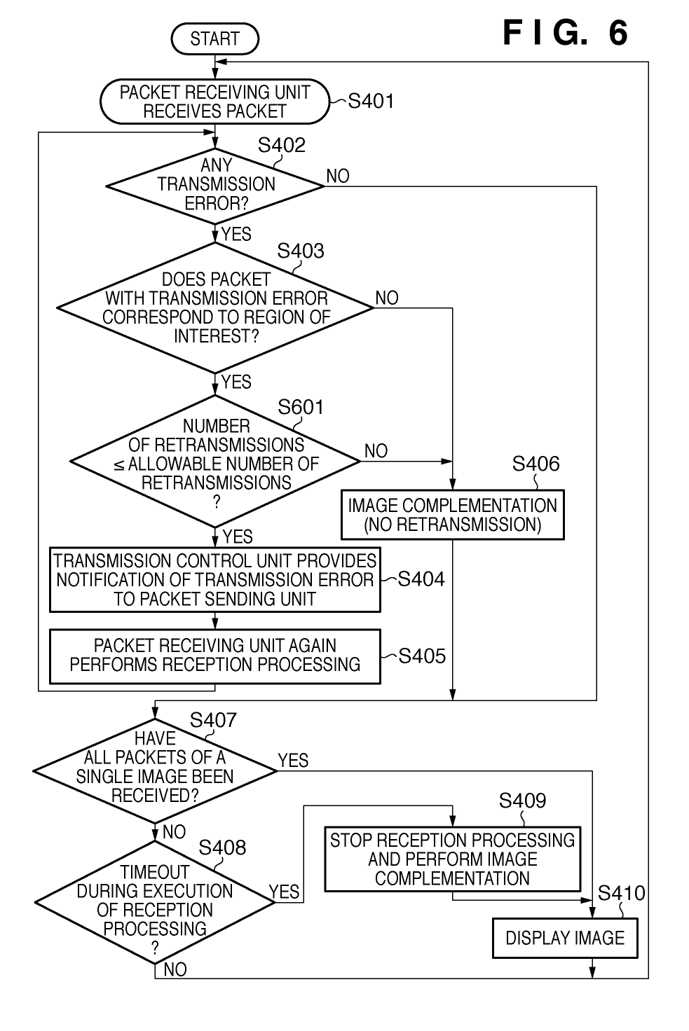

The diagnostic apparatus 101 according to the present exemplary embodiment has similar preconditions and a similar configuration (FIGS. 1, 2, and 3) to the diagnostic apparatus 101 according to the first exemplary embodiment. Thus, only the parts that are different from those in the first exemplary embodiment will be described with reference to FIG. 6, and common parts are not described herein.

Reception Processing

FIG. 6 is a flow chart showing an operation of the display device 104 when receiving an image. The flow chart shown in FIG. 6 differs from the flow chart shown in FIG. 4 in the inclusion of step S601. Specifically, in the present exemplary embodiment, the process proceeds to step S601 when a packet that has encountered a transmission error is determined as corresponding to a region of interest in step S403 (YES in step S403).

In step S601, it is determined whether or not the number of retransmissions per packet falls within a predetermined allowable number of retransmissions. If it falls within the allowable number of retransmissions (YES in step S601), the process proceeds to step S404 for retransmission. If it exceeds the allowable number of retransmissions (NO in step S601), on the other hand, the process proceeds to step S406 to stop retransmission and to perform image complementation. Note that the number of retransmissions is counted by the transmission control unit 110.

Here, an allowable number of retransmissions is set in order to reduce the possibility that a timeout may occur due to the delays associated with retransmission and, thereby, the following packets may not be transmitted. However, if the preset allowable number of retransmissions is too small, it is difficult to secure sufficiently high reliability in the image for a region of interest. The present exemplary embodiment may thus adopt a mode of operation in which a doctor or a person in charge of maintenance of the diagnostic apparatus 101 will set an appropriate allowable number of retransmissions after considering the above trade-off.

As described above, in the present exemplary embodiment, the number of times that a retransmission request was transmitted is counted for each packet. When a transmission error has been detected in a packet, the sending of a retransmission request for the packet is repeated until either the packet can be received without any transmission error or the number of retransmissions counted for the packet exceeds a predetermined upper limit. The configuration of the present exemplary embodiment can thus avoid the endless issuance of a retransmission requests when a transmission error continues to occur.

### Embodiment 3

Next, a diagnostic apparatus 101 according to a third exemplary embodiment (Embodiment 3) of the present invention will be described. A configuration according to the present exemplary embodiment maintains the reliability of an entire image by also retransmitting a packet that does not correspond to a region of interest when all packets that correspond to the region of interest have been transmitted properly and also a timeout period has not expired yet.

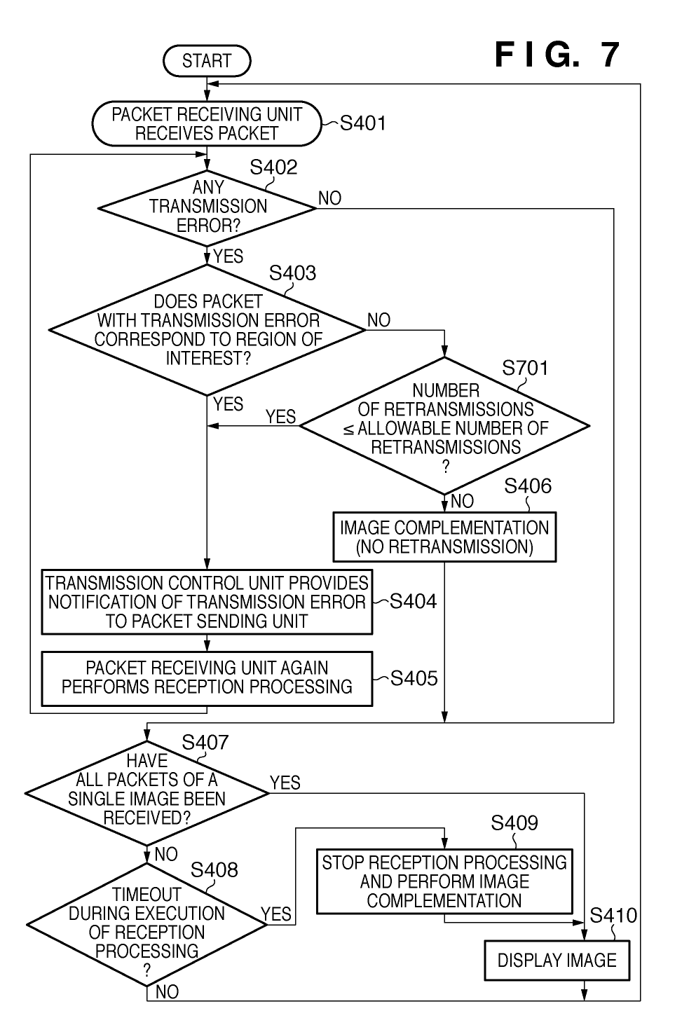

The diagnostic apparatus 101 according to the present exemplary embodiment has similar preconditions and a similar configuration (FIGS. 1, 2, and 3) to the diagnostic apparatus 101 according to the first exemplary embodiment. Thus, only the parts that are different from those in the first exemplary embodiment will be described with reference to FIG. 7, and common parts are not described herein.

Reception Processing

FIG. 7 is a flow chart showing an operation of the display device 104 when receiving an image. The flow chart shown in FIG. 7 differs from the flow chart shown in FIG. 4 in the inclusion of step S701. Specifically, in the present exemplary embodiment, the process proceeds to step S701 when a packet that has encountered a transmission error is determined as not corresponding to a region of interest in step S403 (No in step S403).

In step S701, as in step S601 (FIG. 6) of Embodiment 2, it is determined whether or not the number of retransmissions of a certain packet falls within an allowable number of retransmissions. The number of retransmissions is set as described in Embodiment 2.

In Embodiment 2, step S601 is performed when a transmission error has been detected in a packet that corresponds to a region of interest. The present exemplary embodiment differs from Embodiment 2 in that step S701 is performed when a transmission error has been detected in a packet that does not correspond to a region of interest. Specifically, in the present exemplary embodiment, the retransmission of a packet that corresponds to a region of interest is repeated endlessly until the transmission succeeds, whereas the retransmission of a packet that does not correspond to a region of interest is performed within a range of the allowable number of retransmissions. This also allows improvements in the reliability of an entire image while giving a high priority to the reliability of an image corresponding to a region of interest.

Note that the present exemplary embodiment may be combined with the second exemplary embodiment: an allowable number of retransmissions may be set individually for a packet that corresponds to a region of interest and a packet that does not correspond to a region of interest.

In the present exemplary embodiment, an upper limit for packet retransmission is set separately for a packet that corresponds to a region of interest and a packet that does not correspond. At this time, the upper limit for a packet that corresponds to a region of interest is higher than the upper limit for a packet that does not correspond to a region of interest. The configuration of the present exemplary embodiment can thus also improve the reliability of a region other than a region of interest as much as possible, while securing high reliability for a region of interest.

### Additional Embodiments

The aim of the present invention is, needless to say, also achieved by executing the program code of software that realizes the functions of the foregoing embodiments in a system or apparatus. In this case, the program code itself realizes the functions of the foregoing embodiments, and this program code is included within the technical scope of the present invention.

The program code can be supplied to the system or apparatus by being recorded to a computer-readable storage medium, for example. A computer (or CPU or MPU) in the system or apparatus can also achieve the aim of the present invention by reading out and executing the program code stored in the storage medium. Accordingly, the storage medium storing this program code is also included within the technical scope of the present invention.

Storage media that can be used for supplying the program code include, for example, flexible disks, hard disks, optical disks, magneto-optical disks, CD-ROMs, CD-Rs, magnetic tapes, nonvolatile memory cards, ROMs, and DVDs.

Moreover, the program code need not have all of the elements for realizing the functions of the foregoing embodiments as a result of a computer reading out and executing the program code. That is, program code that achieves the aim of the invention in coordination with at least one of software or hardware incorporated in a computer is also included.

For example, in the case where an OS or the like running on a computer performs part or all of the actual processing based on instructions in the program code, and the functions of the foregoing embodiments are realized as a result of this processing, this program code is also included within the technical scope of the present invention. Here, OS stands for operating system.

Alternatively, a CPU or the like provided in a function expansion board or a function expansion unit inserted in or connected to a computer may perform part or all of the actual processing based on instructions in the program code, with the functions of the foregoing embodiments being realized as a result of this processing. The program code in such a case is also included within the technical scope of the present invention. Note that such a function expansion board or such a function expansion unit is able to perform such processing by reading the program code to a memory provided therein and executing the read program code.

As described above, image transmission in packet communications generally faces the problem that the reliability of an image is reduced if retransmission is not performed when a transmission error occurs, whereas delays may occur if retransmission is performed. Conventional techniques could not avoid such a reduction in the reliability of images if no delay due to retransmission is allowed because of real-time constraints. With the configurations described in the above exemplary embodiments, on the other hand, whether to retransmit a packet or not depends on whether or not the packet corresponds to an interesting region (i.e., a region of interest) for an image observer. In addition, retransmission of a packet that corresponds to a region of interest is given a higher priority than transmission of a packet that does not correspond to a region of interest. The above-described configurations can thus secure the reliability of a transmitted image regarding a region of interest while allowing real-time image transmission.

According to the present invention, a technique can be provided that enables image data to be transmitted while securing the required reliability, through a communication path that does not always secure the reliability of data transmission.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-220503, filed on Aug. 28, 2008, which is hereby incorporated by reference herein in its entirety.

What is claimed is:

1. An information processing apparatus that receives image data sent from a sending apparatus in packet communications, the information processing apparatus comprising:
a receiving unit adapted to receive a packet for transmitting the image data;
a detecting unit adapted to detect a transmission error in the packet; and
a sending unit adapted to send a retransmission request for a packet in which the detecting unit has detected a transmission error to the sending apparatus;
wherein, when the detecting unit has detected a transmission error in a packet that corresponds to a region of interest that has been preset in the image data, the sending unit sends a retransmission request for the packet with a higher priority than a transmission request for a packet that does not correspond to the region of interest.

2. The information processing apparatus according to claim 1, further comprising:
a counting unit adapted to count a number of times per packet that the sending unit sends the retransmission request;
wherein, when a transmission error has been detected in a packet, the sending unit repeatedly sends a retransmission request for the packet until either the receiving unit receives the packet without any transmission error or the number of times counted by the counting unit for the packet exceeds a predetermined upper limit.

3. The information processing apparatus according to claim 2, wherein
the upper limit is set separately for a packet that corresponds to the region of interest and a packet that does not correspond to the region of interest, and
the upper limit for a packet that corresponds to the region of interest is higher than the upper limit for a packet that does not correspond to the region of interest.

4. The information processing apparatus according to claim 1, wherein
when a transmission error has been detected in a packet that does not correspond to the region of interest, the sending unit does not send a retransmission request for the packet.

5. The information processing apparatus according to claim 1, further comprising:
a measuring unit adapted to measure an elapsed time after starting to receive packets of the image data;
wherein, when the elapsed time measured by the measuring unit exceeds a predetermined upper limit, the receiving unit stops receiving the packets.

6. The information processing apparatus according to claim 1, further comprising a setting unit adapted to set the region of interest according to a user instruction.

7. A method of controlling an information processing apparatus that receives image data sent from a sending apparatus in packet communications, the method comprising:
a receiving step of receiving a packet for transmitting the image data;
a detecting step of detecting a transmission error in the packet; and
a sending step of sending a retransmission request for a packet in which a transmission error has been detected in the detecting step to the sending apparatus;
wherein, when a transmission error in a packet that corresponds to a region of interest that has been preset in the image data has been detected in the detecting step, a retransmission request for the packet is sent in the sending step with a higher priority than a transmission request for a packet that does not correspond to the region of interest.

8. A program stored in a computer-readable storage medium that causes a computer to function as an information processing apparatus according to claim 1.

9. A computer-readable storage medium that stores a program according to claim 8.
